(19) United States
(12) Patent Application Publication
(10) Pub. No.: US 2002/0072980 A1
(43) Pub. Date: Jun. 13, 2002

(54) System, method, and program for managing electronic shopping carts

(76) Inventor: Rabindranath Dutta, Austin, TX (US)

Correspondence Address: Kevin L. Daffer, Conley, Rose & Tayon, P.C., P.O. Box 398, Austin, TX, 78767-0398, US

(21) Appl. No.: 09/732,480

(22) Filed: Dec. 7, 2000

(51) Int. Cl. G06F 17/60

(52) U.S. Cl. 705/26

(57) ABSTRACT

In a system, method, and program for conducting electronic commerce over a network, products being considered for purchase are examined and a status of the products may be informed to a shopper. A notification message regarding the product inventory status may be issued and be selectively performed according to a profile of the shopper. The message may be issued by various messaging services including electronic mail, instant messaging, and a real-time output display. A system for implementing the methods may include an electronic commerce server. The electronic commerce server may be coupled to a web server to interface with a plurality of network clients. The electronic commerce server may include one or more storage devices containing program instructions and data to perform the methods described herein. The program instructions may be included on a carrier medium, which may be a transmission or storage medium.

### BACKGROUND OF THE INVENTION

1. Field of the Invention

This invention relates generally to electronic commerce and more particularly to a system, method, and program for conducting electronic commerce over a network by managing electronic shopping carts with order conversion rates to perform inventory control of products being offered to customers by an online vendor.

2. Description of the Related Art

The following descriptions and examples are not admitted to be prior art by virtue of their inclusion within this section.

The Internet comprises a vast number of computers and computer networks that are globally interconnected through communication links. The connected computers presently communicate with each other via a set of protocols called TCP/IP (Transmission Control Protocol/Internet Protocol). An especially popular aspect of the Internet is the World Wide Web (“WWW” or “Web”), which is a collection of interlinked documents. These documents or “web pages” may incorporate text, graphics, audio, and/or video content, and may include links to one another, often called “hyperlinks.” The WWW service allows a server computer system (i.e., Web server or Web site) to send web pages, stored on a server-side storage medium, of information to a remote client computer system. The remote client computer system can then display the web pages via a web browser, a software application that typically resides on the client computer system. Two of the more popular graphical web browsers available include Microsoft's Internet Explorer and Netscape Communications' Netscape Navigator.

The Web may utilize a messaging protocol known as the HyperText Transfer Protocol (“HTTP”) for exchanging information contained in the web pages. HTTP defines how the information is formatted and transmitted, and what actions the Web servers and Web browsers should perform in response to the client inputs. Web pages may be defined using the HyperText Markup Language (“HTML”) standard. HTML provides a standard set of tags that define how a Web page is to be displayed. Each web page is uniquely identifiable by a Uniform Resource Locator (URL), an Internet standard syntax for the global addresses of web pages. Therefore, in an exemplary WWW communication process, a user (on a client computer system) accessing the WWW through a web browser specifies the URL for a specific web page through a HTTP request. The request is forwarded to the Web server that supports that web page. Upon receiving the HTTP request, the Web server sends that web page, in HTML format, to the client computer system. The web browser translates the HTML formatted web page and displays it on the client computer system for viewing by the user.

Because of its ease of use and visually appealing interface, the WWW is especially conducive to conducting electronic commerce. Coupled with the global penetration of the Internet, online vendors are provided with the capability to effortlessly retail their products globally to shoppers, or buyers, using an online shopping system. Online shopping systems enable vendors to creatively display and describe their products, or merchandise, to potential shoppers. These systems allow shoppers to browse through a vendor's online store to identify products of interest, to obtain specific product information and to electronically purchase products after reviewing the product information. Due to its electronic nature, the selection of various products by shoppers is oftenly based on a virtual “shopping cart” model. When a shopper selects a product or products for purchase, the server computer system metaphorically adds that item to the online shopping cart. When the shopper is finished selecting products, the products placed in the online shopping cart are then “checked out” (i.e., ordered) when the shopper provides payment and shipping information. For these reasons, many electronic commerce (“e-commerce”) applications and servers have been developed through which vendors may advertise and sell their products to shoppers.

The concept of online shopping makes for problematic execution on the WWW, however. Because HTTP uses a stateless request/response paradigm, where the electronic information sent between networked computers can be categorized as either requests for information, or responses to those requests, HTTP does not provide for maintaining any type of state information about the communications. Instead, HTTP treats each request/response pair as separate unrelated transactions. Although this approach may be suitable for most Web transactions, such as information retrieval, there are many instances where this lack of state information is a serious shortcoming of the protocol. When there is no state information, a server receiving requests from a client may have no way of knowing that it has received prior requests from the same client, and thus no way of making any sort of logical connection between the multiple requests. Such a scenario frequently occurs in online shopping transactions, in which shoppers routinely purchase multiple products or “put back” products no longer desired before checking out. Without some provision for maintaining state information, an online shopping website would require the buyer to immediately check out upon selecting an item for purchase.

To alleviate the shortcomings of HTTP, a Session Identifier (“Session ID”) may be associated with each client communicating with the Web server. A Session ID may be any type of identifier that serves to uniquely identify a particular client to the server. This Session ID is then sent as part of the HTTP request syntax for each message sent from the client computer system. The Web server uses the Session ID to store information related to the transactions with this client, so that the series of transactions can be treated as a logical continual communication between the client computer system and the Web server. By employing Session IDs, an e-commerce server is able to accumulate the information required for a shopper to conduct online shopping. A popular approach employing this technique is through the use of a “cookie,” which stores user-specific information on a client computer system. When a client issues a first request to a Web server, the Web server will create a cookie for this client, and assigns a session ID to this cookie. The cookie for the session is then passed back to the client with the response. On subsequent requests by the same client, the client sends the session cookie as part of the request to the Web server, thus allowing the Web server to retrieve client specific information it has kept on previous transactions with this client. The cookie is typically created by a program script associated with a web page, or online shopping site for e-commerce activities, being visited, and sent to the client computer system where it is stored in a text file. The text file may contain multiple cookies associated with various web pages that the user on the client computer system has previously visited. Another approach utilizes a technique known as “URL rewriting.” URL rewriting is a method of attaching a Session ID into the URL syntax. By inserting the Session ID into the URL, the Web server can maintain state information for that session. In this method, processing by the Web server is required for URL rewriting. In particular, prior to sending a web page to the client computer system, the Web server checks the web page for embedded URLs. If so, the Web server proceeds to add a Session ID parameter and the unique identifier for this session into the URL syntax before sending the web page. Once embedded into the URL, the Session ID allows the Web server to correctly identify ongoing requests from a client and maintain a continuous session with the client.

The use of a cookie and URL rewriting are examples of what may be referred to as “persistent information,” or information resulting from a network session involving a client computer that remains on the server and/or client computer during the session. In the case of a cookie, the information may further be stored on either the server or client computer after the session has ended. When used in online shopping sites employing an electronic shopping cart model, the electronic shopping carts are then referred to as “persistent” shopping carts. Electronic shopping carts can exhibit different degrees of persistence. In the case of shopping carts using URL rewriting methods, information such as the type and quantity of items placed into the shopping cart by the buyer can be retained for the current session. These shopping carts may be termed “single-session” persistent shopping carts. For those which utilize a cookie, the information can be preserved across multiple sessions, and may be called “multi-session” persistent shopping carts. Regardless of the persistence type, persistent electronic shopping carts are becoming rather popular among the e-commerce websites. They conveniently allow a shopper to “window” shop by placing products into the shopping cart and continue shopping or leave the e-commerce website without checking out. For single-session persistent shopping carts, the shopper can continue shopping on the website for that current session prior to checking out after finalizing the merchandise selection to purchase. For multi-session persistent shopping carts, the shopper may leave the website and return to it at a later period. The shopper may then continue shopping at the website as though the buyer had never “left” the online shopping site. The information concerning the types and quantity of merchandise residing in the buyer's shopping cart may be stored in a cookie or a file associated with a cookie. This cookie allows the e-commerce Web server to identify the shopper and retrieve the previous session information so the shopper can conveniently “pick up” where he/she left off. In contrast, for a non-persistent shopping cart, shoppers, who comparison shop at different sites or routinely decide on buying the products after the initial visit, would be required to then “re-shop” by selecting the merchandise again. By using a persistent shopping cart, e-commerce Websites can save the buyer trouble of re-shopping and allow the shopper the convenience of comparison-shopping or continued shopping before checking out.

Although convenient for the shopper, electronic shopping carts become rather problematic for the vendor. In particular, persistent shopping carts make product inventory control very difficult to handle and estimate, particularly when there is a limited supply of merchandise on-hand to sell. Because the shopper is allowed to place products into the shopping cart and either continue shopping or leave the online shopping site, the products being considered for purchase by the shopper cannot be assumed “sold” by the e-commerce server. In these instances, shoppers may eventually decide to purchase the products selected, a portion of the selected products, or none of the selected products at all. Only upon check out would an e-commerce server be able to update the product inventory to reflect a completed transaction. Because a plurality of shoppers may be browsing the product selection on the vendor's website however, frequent situations may occur in which a shopper returning to purchase a previously selected product or purchase the selected product after continuing to browse the site, may be denied sale due to the product(s) being out of stock or sold to other shoppers. This may be attributed, in one example, to other shoppers returning to the e-commerce website, before the shopper being denied the sale, and completing their transactions. In addition, shoppers who do not leave the website prior to finalizing their purchase may also experience such a similar situation. For example, multiple shoppers may be placing the product(s) into their shopping carts and intending to check out in the same session. However, if the product(s) is currently limited in supply, the shoppers who then proceed to check out first would receive the products, while the shopper(s) who checks out after the supply has been exhausted, may experience a delay in shipment. Experiencing these situations as described, the shopper who could not finalize the transaction may become irritated or angry by the lack of availability, although the product was previously put in the shopping cart and therefore assumed to be “in-stock.” In some cases, the shopper may then decide to purchase the product elsewhere or in extreme cases, decide to permanently take their business to another competing vendor website. In both scenarios, the online shopping vendor would lose immediate potential profits and more seriously, a repeat customer who frequently are the backbone of continuing profits for the vendor.

It would therefore be desirable to implement a method for managing electronic shopping carts to provide improved product inventory control and estimation. Such a method may then avoid situations as those described above and perhaps further allow the vendor to conduct promotional sales smoothly, in which the promotional sales attract a large base of shoppers to vie for a limited supply of the product(s) being offered. Ultimately, the method should maximize a vendor's sales potential by providing a pleasant shopping experience to the buyers, who then have a higher probability of returning to the online shopping site for future purchases.

### SUMMARY OF THE INVENTION

The problems outlined above are in large part addressed by a system, method, and program for managing electronic shopping carts used in conducting electronic commerce over a network such as the Internet. Shopping carts as used herein may refer to a file or files associated with entries identifying items of merchandise considered for purchasing by a buyer. The systems, methods, and programs described herein are equally applicable to both non-persistent and persistent electronic shopping carts.

In an embodiment of a method for conducting electronic commerce over a network, an inventory status of at least one product, being considered for purchase by a buyer, is determined. Upon determining the inventory status, the buyer may be informed of a change in the inventory status prior to any purchase of the product by the buyer. The inventory status and change in inventory status may include various types of information. For example, the status may include a level of availability of the product to be shipped to the buyer. Alternatively, the status may include a probability of immediate shipment of the product upon purchase by the buyer. The status may also include a number of other buyers considering the product for purchase. Informing the buyer of the change in inventory status may include informing the buyer that the product is nearing depletion in the inventory. Alternatively, the buyer may be informed that the product may not be available for shipment unless the product is purchased within a specific timeframe. The means for informing the buyer may vary. The buyer may be sent a notification message via an electronic mail service. Notification may also be performed by an instant messaging service or by displaying the message, inside a dynamic content window, onto a video display screen viewable by the buyer. Various programming scripts, such as a Java applet or an ActiveX control, may generate the dynamic content window for example. Upon issuing the notification message, if the product is not checked out, or purchased, within the specific timeframe, the product may not be guaranteed for immediate shipment.

The notification message may be issued according to a notification algorithm. The algorithm may first determine a current inventory quantity of the product. Current inventory may be defined as in-stock merchandise available for shipment upon purchase by a buyer. An aggregate quantity of the product may also be determined in all currently unfulfilled electronic shopping carts. Unfulfilled shopping carts may include those carts that have not been checked out. A conversion rate factor may then be applied to the inventory quantity to generate a first notification quantity value. The aggregate quantity may then be compared to the first notification quantity and the notification message may then be issued to the buyer if the aggregate quantity is equal to or greater than the first notification quantity value. In an alternative embodiment, a safety margin factor may further be applied to the first notification quantity value to generate a second notification quantity value. The aggregate quantity may then be compared to the second notification quantity value and a notification message may be issued if the aggregate quantity is equal to or greater than the second notification quantity value. Generally speaking, a notification message may be sent to a buyer if the notification quantity threshold is equaled or exceeded by the total number of the product residing in all currently unfulfilled electronic shopping carts.

Informing the buyer of a change in the inventory status of the product may also be selectively performed based upon a buyer's profile. Buyers with similar profiles, as determined according to a vendor's classification, may be grouped accordingly and a notification rank may be assigned to each group. When the notification quantity threshold is equaled or exceeded, a notification message may selectively be issued to the buyers according to their assigned notification rank value. Groups that have a higher notification rank may be initially issued the message before groups that possess a lower notification rank. If the notification quantity threshold may still persist upon issuing the notification threshold to the highest ranked group, the message may then be issued to the next highest ranked group and so forth.

An embodiment of a system for conducting electronic commerce over a network includes a server adapted to perform embodiments of the methods described herein. The server may be adapted to determine an inventory status of at least one product being considered for purchase by a buyer and may be further adapted to inform the buyer of a change in the inventory status before any purchase of the product by the buyer. The server may be further adapted to inform the buyer that the product may not be available for shipment unless the product is purchased within a specific timeframe. The server may also be adapted to compare the inventory quantity of the product to the aggregate quantity of the product currently considered for purchase by all buyers. The server may also be adapted to generate a first notification quantity value by applying a conversion rate factor to the inventory quantity and to generate a second notification quantity value by applying a safety margin factor to the first notification quantity value. The server may then be adapted to inform the buyer if the value of the aggregate quantity is equal to or greater than either the first or the second notification quantity value. The server may be adapted to inform the buyer using a communication means as discussed above and may also be adapted to selectively inform the buyer based on a ranked profile of the buyer.

Another embodiment of a system for conducting electronic commerce over a network is contemplated. The system may include an electronic commerce server including notification instructions, stored on one or more storage devices, for informing a buyer of a change in the inventory status of a product, being considered for purchase, before any purchase of the product by the buyer. The notification instructions may include instructions for generating a notification quantity value by applying a conversion rate factor to an inventory quantity of the product and informing the buyer if the notification quantity value is equal to or greater than an aggregate quantity of the product currently being considered for purchase by all buyers. The notification instructions may further include instructions for selectively informing the buyer based on a ranked profile of the buyer. The electronic commerce server may further include one or more databases stored on the storage device. The database may include notification data including the inventory quantity, the aggregate quantity, the conversion rate factor, and the notification quantity value. The database may further include notification data associated with the ranked profile of the buyer. The system may also include a web server coupled to the electronic commerce server and adapted to interface with one or more network clients. The network clients may provide means for one or more buyers to conduct electronic commerce transactions with the electronic commerce server.

A computer-usable carrier medium is also contemplated herein. The carrier medium may be a storage medium, such as a magnetic or optical disk, a magnetic tape, or a memory. In addition, the carrier medium may be a transmission medium, such as a wire, cable, or wireless medium along which data or program instructions are transmitted, or a signal carrying the data or program instructions along such a wire, cable, or wireless medium The carrier medium may include program instructions executable on a computational device. The program instructions may include first program instructions executable for determining an inventory status of at least one product being considered for purchase by a buyer and second program instructions executable for informing the buyer of a change in the inventory status before any purchase of the product by the buyer. The first program instructions may further be executable for determining an inventory quantity of the product and for determining an aggregate quantity of the product currently being considered for purchase by all buyers. The first program instructions may also be executable for generating a first notification quantity value by applying a conversion rate factor to the inventory quantity and generating a second notification value by applying a safety margin factor to the first notification quantity value. The second program instructions may further be executable for informing the buyer if either the first or second notification quantity value if equal to or greater than the aggregate quantity. The second program instructions may also be executable for selectively informing the buyer based on a ranked profile of the buyer and for informing the buyer that the product may not be available for shipment if the product is not purchased within a specific timeframe. The second program instructions may further be executable to inform the buyer using a communication means as described above.

### BRIEF DESCRIPTION OF THE DRAWINGS

Other objects and advantages of the invention will become apparent upon reading the following detailed description and upon reference to the accompanying drawings in which:

FIG. 1 is a block diagram illustrating an exemplary system that may be used to implement embodiments of the methods described herein.

FIG. 2 is a block diagram illustrating an exemplary server that may be used to implement embodiments of the system and methods described herein.

FIG. 3 is a portion of exemplary database table used in online shopping systems.

FIG. 4 is a portion of an exemplary database table that may be employed in embodiments of the system and method described herein.

FIG. 5 is a flow diagram illustrating an embodiment of a method for managing electronic shopping carts as described herein.

FIG. 6 is an exemplary notification message that may be used by embodiments of the system and method recited herein.

FIG. 7 is an exemplary shopping cart status display that may be used by embodiments of the system and method recited herein.

FIG. 8 is a portion of an exemplary database table that may be employed in embodiments of the system and method described herein.

FIG. 9 is a portion of an exemplary database table that may be employed in embodiments of the system and method described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

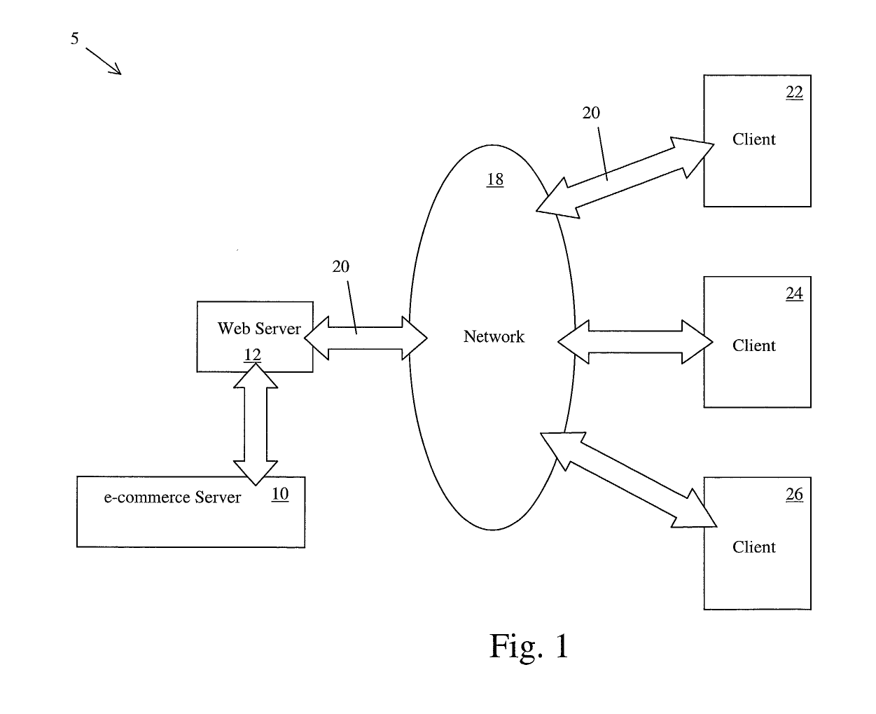

An illustration of an exemplary networking system 5 that may be employed by embodiments of the methods herein is shown in FIG. 1. System 5 may include electronic commerce (“e-commerce”) server 10, web server 12, and at least one client 22 (or a plurality of clients 22, 24, and 26 as depicted) that communicate with each other over network 18 by way of transmission medium 20. Network 18 may be TCP/IP network, such as the Internet and the World Wide Web, or any other network system such as, Local-Area Network (LAN), Wide-Area Network (WAN), System Area Network (SAN), Ethernet, or Token Ring, for example. Alternatively, there may be separate and different networks between e-commerce server 10, web server 12, and clients 22, 24, and 26 (“client devices”). Although illustratively shown as networking three clients 22, 24, and 26, networking system 5 may include any number of clients depending on the network architecture being employed or the number of clients currently connected to the network. Accordingly, the methods described herein are equally applicable to any number of network clients. Transmission medium 20 may be used to connect e-commerce server 10 and web server 12 to the plurality of client devices and may include, for example, a wire, cable, wireless transmission path, or a combination of these. Protocols used for communicating along transmission medium 20 may include, but are not limited to, TCP/IP, HTTP, Wireless Applications Protocol (WAP), File Transfer Protocol (FTP) and Gopher.

Web server 12 may be a computational device that may serve as the network communications interface logic between e-commerce server 10, network 18, and the client devices. Some exemplary Web servers that may be suitable for implementing the methods described herein include Microsoft's Internet Information Server™, IBM's WebSphere™, or an Apache HTTP Web server. Other commercially available Web servers may also be utilized. Web server 12 may exchange information files (e.g. Web pages) with clients 22, 24, and 26 through HTML or other suitable languages such as Extensible Markup Language (XML) or Wireless Markup Language (WML), for example. Generally speaking, web server 12 may handle the technical mechanics of protocol communications between e-commerce server 10 and the client devices over network 18. Consequently, web server 12 may include various hardware and software elements not shown for simplification purposes. For example, web server 12 may include one or more processors and one or more storage devices. The storage devices, or storage medium, as referred to herein may take many forms, such as volatile or non-volatile memory, a magnetic disk such as a hard drive or floppy drive, an optical disk, and/or magnetic tape. The storage device may include files and program instructions, which may be executable to implement the networking functions of web server 12. Files, as used herein, may refer to any collection of data suitable for storing or transferring throughout a network.

Client devices may be linked to network 18 via transmission medium 20. Broadly speaking, client devices are understood to encompass any computational device adapted to link to network 18 to allow communications with web server 12 and e-commerce server 10. Although traditionally defined as a desktop or laptop device, the computational device may also be a portable computational device such as a personal digital assistant (PDA), a cellular phone with network access capabilities, or a dedicated appliance (known as an networking appliance) designed to connect to a network, such as the Internet for example. In similar fashion, client devices may include appropriate networking hardware and software interfaces to link with network 18. For example, each client may include one or more processors and one or more storage devices. The storage device may include files and program instructions to allow the client to connect to network 18 and communicate with web server 12 and e-commerce server 10. To connect to network 18, the client devices may include a web browser. The web browser may allow a client to access the website of a vendor hosted by e-commerce server 10 and web server 12. The website constitutes the online shopping site in which the users of the client devices may browse and shop for merchandise offered by the vendor. An input device, such as a keyboard and/or mouse, and an output device, such as a video display and/or printer, may further be included to allow a user to interface with the website.

E-commerce server 10 may be coupled to web server 12 and may be configured to manage all or portions of the online shopping transactions. Alternatively, all functionality described herein in regards to e-commerce server 10 may be entirely or be partially performed by web server 12. In an embodiment, web server 12 interfaces with e-commerce server 10 to provide information requests originating from the client devices. Such requests may include requests for product information, for browsing product inventory, for purchasing products, and for tracking product orders. E-commerce server 10 services these requests and outputs the requested information back to web server 12 for transmittal to the client devices.

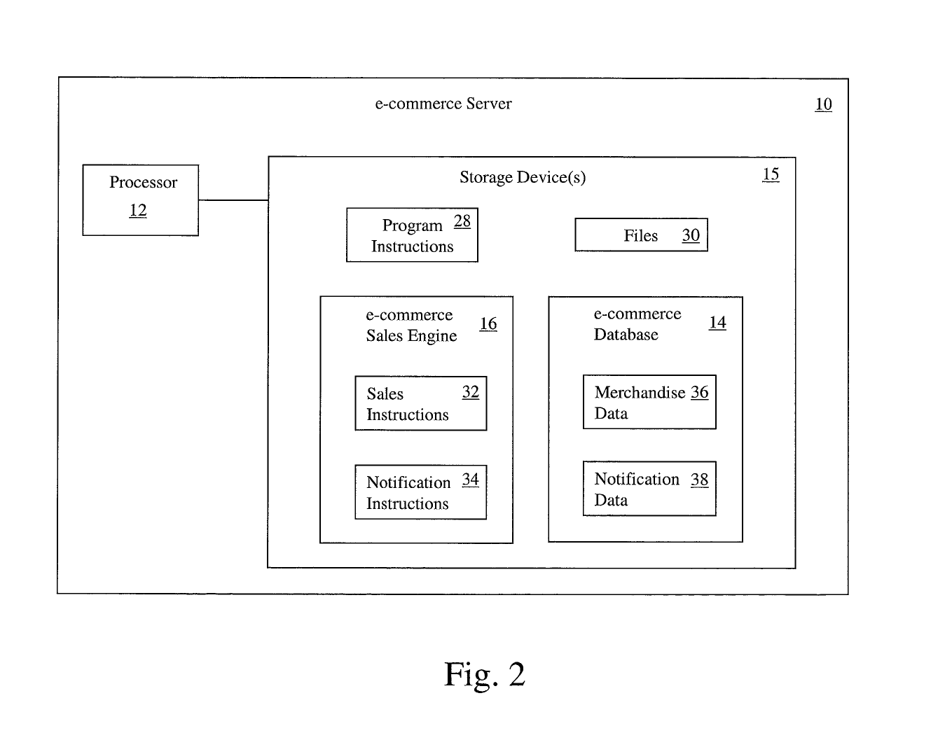

Turning now to FIG. 2, a more detailed block diagram illustrating embodiments of e-commerce server 10 that may be used to implement the methods described herein is shown. E-commerce server 10 may be a computational device and may include one or more processors 12. One or more storage devices 15 may also be included. Storage device 15 may include files 30 and program instructions 28, also referred to as program executables. The program instructions may be stored as “executable files” in a storage device and loaded into system memory during execution. Program instructions 28 may include instructions for interfacing and servicing information requests with web server 12 and network 18. As previously mentioned, files 30 may include any collection of data suitable for storing or transferring over a network such as network 18. For example, files 30 may include documents such as web pages suitable for viewing upon the client devices by users of the network and may contain text, graphics, video and/or audio information.

Storage device 15 may also include e-commerce sales engine 16. Although sales engine 16 may be implemented using program instructions such as instructions 28, e-commerce sales engine 16 is shown separately in FIG. 2 to emphasize this feature of e-commerce server 10. E-commerce sales engine 16 may include sales instructions 32. Sales instructions 32 may include, for example, instructions for executing commerce functions associated with electronic commerce transactions. For example, the instructions may include retrieving product information, handling purchases, tracking orders and so forth. E-commerce sales engine 16 may further include notification instructions 34 which may include instructions for performing the methods described herein (in detail further below). Although shown as separate instruction blocks, sales instructions and notification instructions may be combined to function as one block. Similarly, e-commerce sales engine may be incorporated into program instructions 28 in alternative embodiments. These and other alternate schemes are well within the scope of the invention upon disclosure to one skilled in the art.

Storage device 15 may further include e-commerce database 14, which may store any commerce related information, or data, such as merchandise information, merchandise inventory, and buyer information, for example. The data may be arranged in a database format, and may contain information such as product description, product price, product color, product type, and product inventory, for example. Other information may be arranged in the database as well. Generally speaking, database 14 may contain any information concerning merchandise being offered for sale by a vendor and arranged in a database structure for retrieval and modification by e-commerce server 10. In an embodiment, e-commerce database 14 may include merchandise data 36 that contains information such as those described above. E-commerce database 14 may also include notification data 38 that contains information for performing the methods described herein (in detail further below). Although shown separately, merchandise data 36 and notification data 38 may be a part of a unified database structure.

In FIG. 2 and any other block diagrams appearing herein, the blocks are intended to represent functionality rather than specific structure. Implementation of the represented system using circuitry and/or software could involve combination of multiple blocks into a single circuit, device, or program, or combination of multiple circuits, devices and/or programs to realize the function of a block. For example, e-commerce database 14 may be external to e-commerce server 10. Furthermore, the e-commerce server and clients may themselves include additional elements not shown.

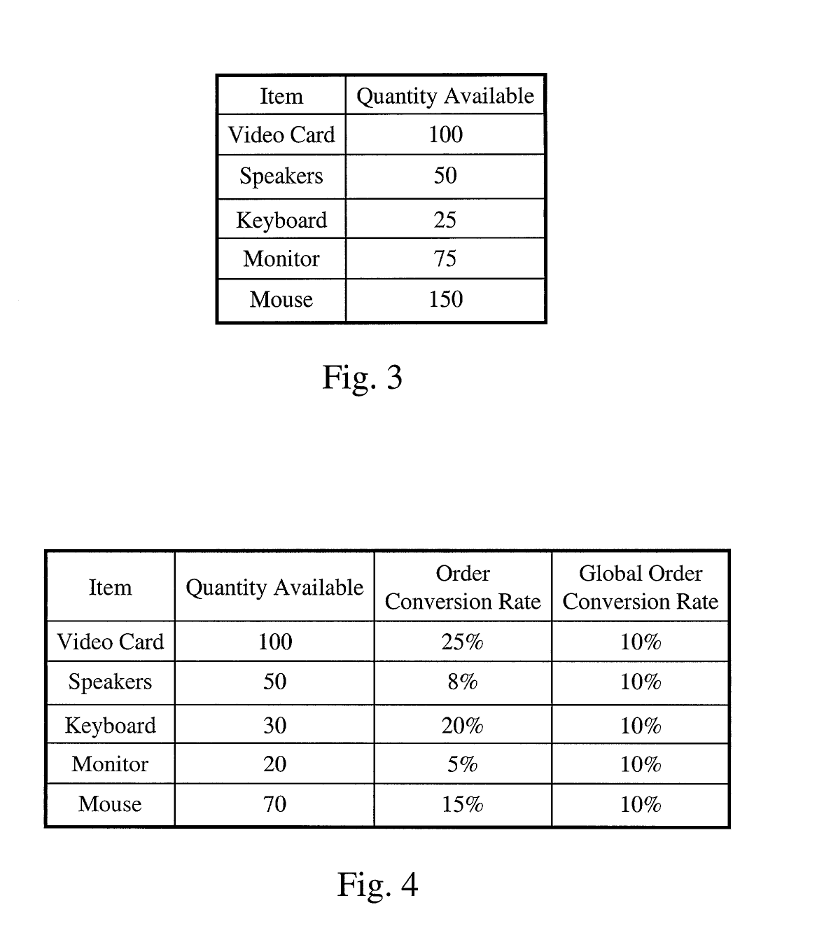

FIG. 3 illustrates a portion of an exemplary database table that may be stored in e-commerce database 14. Other fields may be populated in e-commerce database 14 and are not shown merely for simplification purposes. In an embodiment, these portions may be included in merchandise data 36. The portion may include two data fields, “Item” and “Quantity Available”. The names of the fields appearing herein are illustratively used and are not meant to be limited or to be construed to such specific nomenclature. Broadly speaking, the “Item” field lists the type of merchandise available for purchase from a vendor and the “Quantity Available” field lists the quantity of the merchandise inventory currently in stock and available for purchase by shoppers. The Quantity Available field may decrease to reflect completed transactions of shoppers. In similar fashion, the Quantity Available field may increase to reflect an increase in merchandise availability. For example, the increase may result from a new shipment of the merchandise being received by the vendor. Consequently, the value in this field may be adjusted when a shopper has “checked out” their shopping cart (placed an actual order) or a change in merchandise inventory is experienced.

FIG. 4 shows another portion of an exemplary database table that may be stored in e-commerce database 14. In an embodiment, this portion may be stored in notification data 38. The portion may further include two additional data fields, “Order Conversion Rate (OCR)” and “Global Order Conversion Rate (GOCR)”. OCR may define the estimated percentage of a specific merchandise item that is actually purchased by customers (i.e., checked out) after being placed into their shopping carts. Similarly, GOCR may define the estimated percentage of all merchandise that is actually purchased after being placed into the shopping carts. Intuitively speaking, the GOCR value may be a uniform factor used across all merchandise being sold by a vendor while the OCR value may be a more specific value for a type of merchandise. Considering the example of FIG. 4, the item “Video Card” has an OCR of 25% and a GOCR of 10%. Assuming the total amount of Video Cards placed into shopping carts to be 100, 25 Video Cards may eventually be purchased by shoppers according to the OCR value and 10 Video Cards may eventually be purchased according to the GOCR value. As illustrated in FIG. 4, the OCR value may be specific for each type of merchandise while the GOCR value may be constant across the entire range of merchandise being offered for sale. The value assigned for each of the conversion rate fields may be derived by various means. The values may be assigned based on the transaction history for each item or the transaction histories for all of the merchandise accordingly. For example, a vendor may analyze a portion of or the entire transaction history to generate the values. An initial arbitrary value may also be assigned if sufficient transaction history is initially unavailable. Upon receiving sufficient transaction history data, the values may then be modified to more accurately reflect the merchandise conversion rates. Broadly speaking, the values of the conversion rate fields may be dynamically assigned to account for the quantity of merchandise typically purchased by shoppers when placed into their shopping carts, and thereby provide a prediction of the amount of future merchandise which may ultimately be purchased when placed into the shopping carts.

In embodiments of the methods described herein, a vendor may utilize either of the conversion rate factors for managing electronic shopping carts to improve merchandise inventory control and estimation. As mentioned above, the conversion rate factors provides for an estimation of the fraction of merchandise placed into shopping carts that may be purchased in future transactions by shoppers. Utilization of a conversion rate factor may then allow a greater amount of merchandise being placed into the shopping cart than the actual amount of merchandise in stock, with a reduced probability of unfulfilled orders due to merchandise unavailability. In an embodiment, a conversion rate factor is applied to the quantity of merchandise available to generate a first variable:

Notification Quantity(NQ)=Quantity Available/Conversion Rate. (1)

NQ may define the total number of entries for merchandise allowable in all of the shopping carts, based on the estimated conversion rate factor assigned to that merchandise. As will be discussed in further detail below, NQ may be used to set a decision point upon which an action may be taken to notify the shopper of an change in the inventory status of the merchandise item. By way of example in FIG. 4, the NQ values using both conversion rate factors for the Video Card would be:

NQ(OCR of Video Card)=100/0.25=400. (2)

NQ(GOCR of Video Card)=100/0.10=1000. (3)

In this example, using the OCR value for the Video Card, a total of 400 entries for an item of merchandise may be placed into all the electronic shopping carts currently active on the online shopping website before an action to notify the shopper of a change in the inventory status of the merchandise item may be taken. Similarly, a total of 1000 entries may be placed into the shopping carts if the GOCR value was employed. Naturally, the NQ values are understood to be dynamic values that may change to reflect current inventory conditions based ultimately on final purchases.

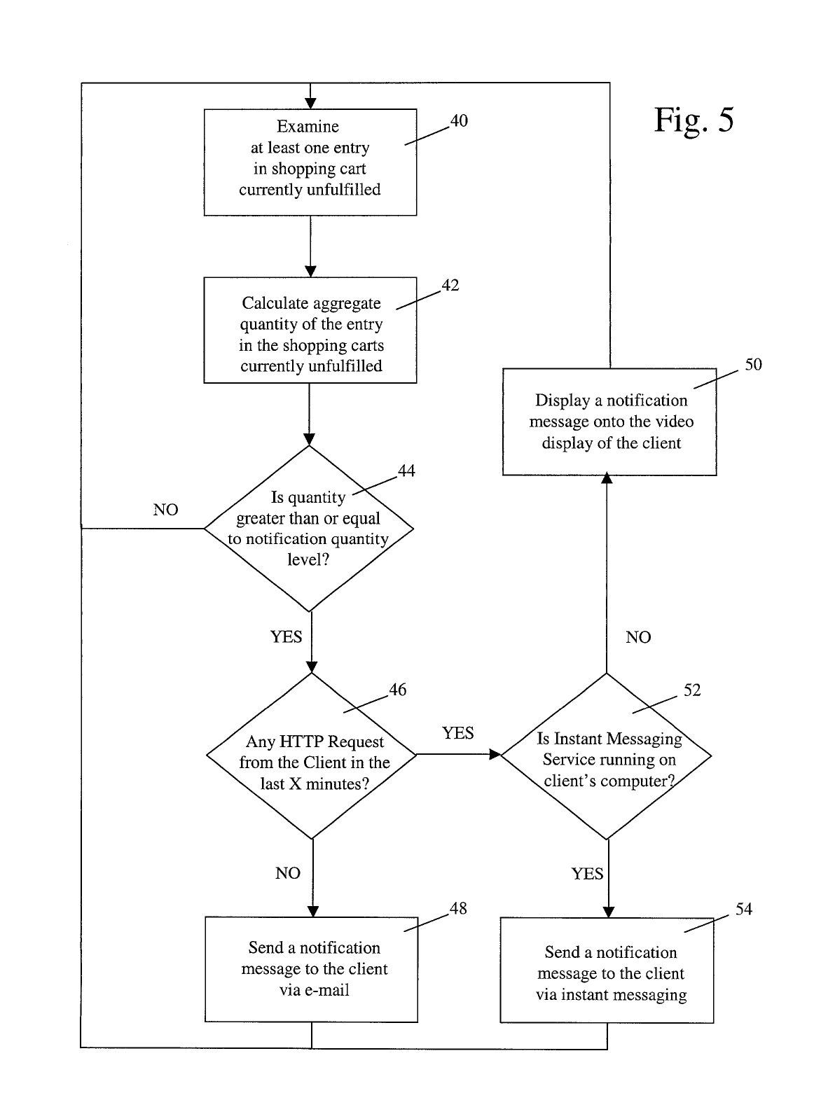

Turning now to FIG. 5, a flow diagram illustrating an embodiment of a method for managing electronic shopping carts for improved merchandise inventory control and estimation is shown. Generally speaking, the method may be applied to electronic shopping carts with varying degrees of persistence and is also equally suitable for non-persistent electronic shopping carts. For simplification purposes, the method describes an algorithm for one shopper with a shopping cart. The method is equally applicable to a plurality of shoppers with a plurality of shopping carts. The method of FIG. 5 may be performed using a system such as system 5 of FIG. 1. The method begins by initially examining at least one entry, corresponding to a type of merchandise, residing in the shopping cart currently unfulfilled (box 40). A shopping cart currently unfulfilled is characterized by a shopping cart that has not been checked out (i.e., completed transactions) and remains pending. The method may then proceed to determine the aggregate quantity of that merchandise currently unfulfilled in all shopping carts (box 42). In an alternative embodiment, the method shown in boxes 40 and 42 may be reversed in sequence; the sequence in which they are performed is not essential. Subsequently, the aggregate quantity of the merchandise examined may be compared to a notification quantity value assigned for that merchandise type. If the aggregate quantity is less than the notification quantity value, the method may then return to examine another entry in the shopping cart as illustrated by the “No” branch of decision box 44. However, if the aggregate quantity is equal to or greater than the notification quantity value, the method may proceed along the “Yes” branch of decision box 44.

This branch may initiate an algorithm for sending to the shopper a notification containing, for example, a message to the effect that the merchandise placed into the shopping cart may not be available for immediate shipping if the merchandise is not checked out promptly. Notification to the shopper may then minimize the amount of dissatisfaction that may arise when the shopper eventually checks out to purchase the merchandise. The notification may further encourage the shopper to complete the purchase and thus allow for increased accuracy in estimating the availability of the item of merchandise being offered for sale. The “Yes” branch of decision box 44 may first determine if a HTTP request from the client has taken place in the previous X minutes (decision box 46). Although exemplified as “minutes”, the duration could certainly be chosen to be any duration a vendor may so choose. The HTTP request may be, for example, any request from the client for additional web pages to be retrieved and transferred to the client. Broadly speaking, the HTTP request may include any transferring of information between the server and the client and may indicate that the shopper, who is connected to the e-commerce server via a client, is still actively browsing the online shopping site. The specific value of the minutes is determined by a vendor and may be five minutes, in one example. If a HTTP request has not been received during the selected time interval, it may be assumed that the shopper is no longer actively connected to the online shopping site. A notification message may then be sent via an electronic messaging service, e.g. electronic mail, (box 48) to the shopper to indicate the status of the merchandise as described above. The e-mail address of the shopper may have been provided by the shopper upon entering the shopping website or stored in a database, which holds customer specific information, on the e-commerce server from a prior session. Customer data may be stored on storage device 15. Alternatively, Customer data may be stored on another storage device not shown. Upon sending the e-mail, the method may then resume by returning back to box 40 to examine another entry in the shopping cart.

However, if a HTTP request has been received by the e-commerce sever during the selected time interval, the method may proceed to determine if an Instant Messaging (IM) service is currently running on the client as shown by the “Yes” branch of decision box 46. Instant messaging is a form of instantaneous communication (commonly referred to as “chat”). There are many variants of IM services presently. Examples of some IM services include America Online's AIM, Microsoft's MSN, Yahoo's Messenger, and ICQ. In addition, the IM service may be a proprietary chat system employed by the vendor to communicate with the shoppers. Consequently, IM service may include any messaging service capable of displaying messages onto an output display device of a client in real-time. If an IM service is currently active on the client, a notification message, as explained above, may be sent to the client as shown by the “Yes” branch of decision box 52 and box 54. The message may be displayed onto an output display device, such as a monitor, connected to the client and viewed by the shopper. The method may then resume by returning to box 40 to perform examination of another entry in the shopping cart. However, if an IM service is not currently active on the client, a notification message may then be displayed onto the output display device of the client as illustrated by the “No” branch of decision box 52 and box 50. Alternatively, decision box 52 may further determine if the user identification for sending the instant message is known. If the user identification is known, the method may proceed to box 54. If the user identification is not known, the method may then proceed to box 50. The notification message may be generated through various software routines. For example, the notification message may be displayed in a dynamic content window programmed to appear on a portion of the output display device. The window may be a part of the web browser software display or external to the web browser software. This may be achieved through a Sun Microsystems' Java script or Microsoft's ActiveX control script. Other software routines known in the art may also be used. Upon displaying the notification message onto the output display device, the method may then return to examine another entry in the shopping cart as shown.

Alternative embodiments to the method described above may also be executed. For example, the method may examine all of the entries in a shopping cart prior to proceeding with determining if a notification message will be issued. In such case, one notification message may be used to summarize all the merchandise that meet the notification criteria as opposed to individually generating a notification message for each separate item of merchandise. An alternative method may also forgo one or more of the notification methods described. For instance, the method may forgo the use of the IM service altogether for simplification reasons. Alternatively, the method may eliminate both e-mail and IM services and rely on displaying a notification message onto the output display device as shown in box 50. Broadly speaking, the methods presented herein may be adapted to vendor preferences and as such, are equally applicable to the many variants which would become apparent with knowledge of this disclosure.

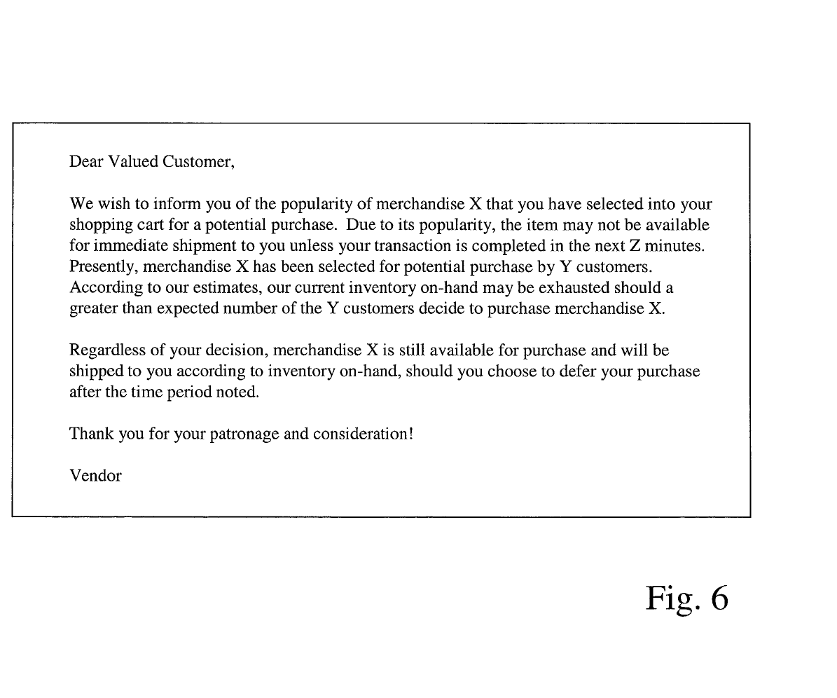

In the methods described herein, a shopper may be issued a notification message concerning the status of at least one entry in the shopping cart. The notification message informs the shopper that at least one entry in the shopping cart may not be available for immediate shipment due to high demand. To ensure the prompt shipment of the merchandise, the shopper is suggested to check out with the shopping cart in a determined time period. If the shopping cart fails to be checked out in the suggested timeframe, availability of the merchandise may no longer be guaranteed. Although the merchandise may no longer be guaranteed, the merchandise may still ship out promptly if the order conversion rate is currently lower than estimated. The contents of the notification message may take on various forms and left to a vendor's preference. FIG. 6 illustrates an exemplary notification message that may be employed. In this example, the notification message informs the shopper of merchandise, “X,” in the shopping cart that might not be available due to its popularity if not purchased in the next “Z” minutes. The message also informs the shopper the quantity of customers, “Y,” who also currently have placed merchandise X into their shopping carts. Naturally, other alternate notification messages may be employed as would be apparent with knowledge of this disclosure. By way of example, the notification message in FIG. 6 may be used when informing the shopper by e-mail, IM, or a dynamic content window as previously discussed. Alternatively, different message formats may be used depending on the messaging system employed.

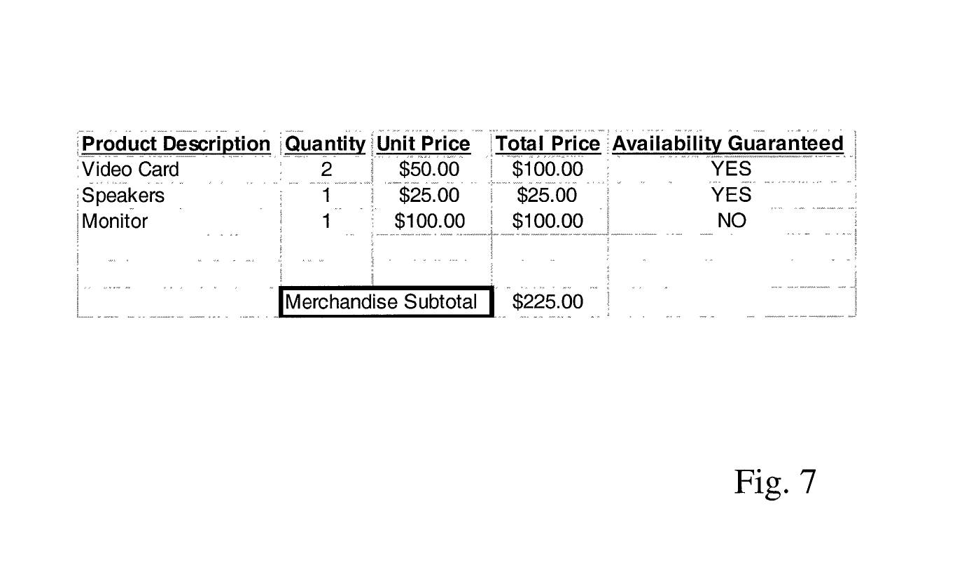

FIG. 7 illustrates a portion of an exemplary shopping cart contents that may be displayed by embodiments of the methods herein. The contents may be displayed onto the output device of a client upon initiation of finalizing the purchase or also be displayed whenever another entry is placed into the shopping cart by a shopper. As discussed above, a shopper may be informed of a time period in which to finalize their purchase to guarantee availability of their merchandise selected. Failing to check out in the time period may result in the merchandise not being guaranteed for immediate shipment. To reflect this information, a field may be populated informing the availability of the merchandise. Merely for illustrative purposes, a field, “Availability Guaranteed” may be present. Accordingly, the items “Video Card” and “Speakers” are flagged as being available, while the item “Monitor” is flagged with no guarantee of availability. Providing this information to the shopper allows the shopper to be better informed on when the merchandises are expected to ship and further make aware to the shopper of the potential for at least one of the merchandise shipment to be delayed.

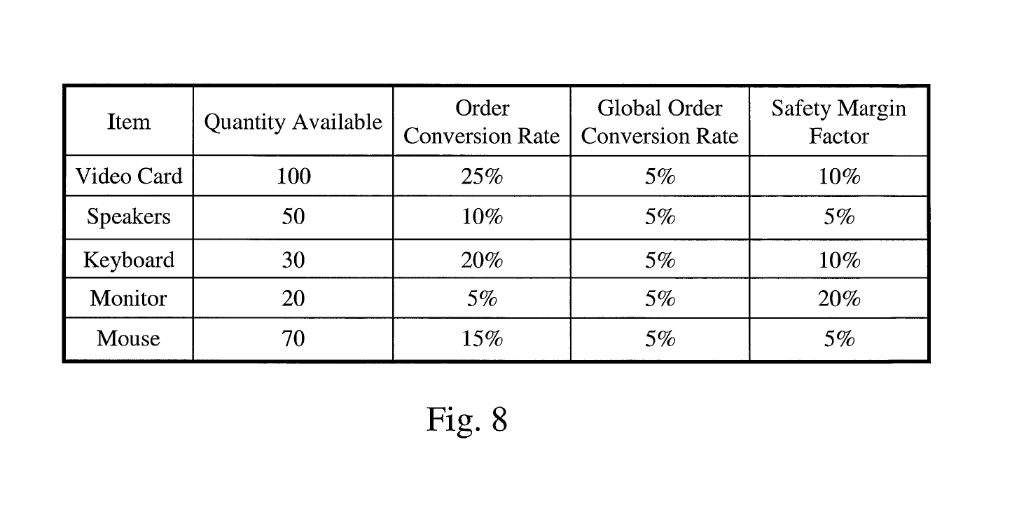

FIG. 8 illustrates yet another portion of an exemplary database table that may be stored on e-commerce database 14. In an embodiment, this portion may also be stored in notification data 38. The portion may further include an additional data field, “Safety Margin Factor,” SMF. SMF may define an error correction factor for either the OCR or GOCR values. Because OCR and GOCR are estimations of the conversion rates for future purchases based on historical transaction data, some degree of error is to be expected. By applying a SMF to either of the conversion rates, the vendor may avoid situations in which the conversion rates may be underestimated and result in merchandise not being shipped to shoppers who were guaranteed its availability. Applying the SMF to either conversion rate results in a Notification Quantity value different from a Notification Quantity value obtained without applying the SMF. To generate this second variable, the SMF may be applied as follows:

Safe Notification Quantity(SNQ)=NQ−(NQ*SMF). (3)

Returning back to the example of FIG. 4, the NQ value of the Video Card item shown in Eq. 2, using the OCR factor, results in:

NQ(OCR of Video Card)=100/0.25=400. (2)

Accordingly, the SNQ value of the Video card, using the OCR factor and the SMF as shown in FIG. 8, becomes:

SNQ(OCR of Video Card)=400−(400*0.10)=360. (4)

Thus, the SNQ value is less than the NQ value for a given item of merchandise. Intuitively speaking, the SNQ value may define a lower threshold quantity before a notification message may be issued to a shopper as described herein. Broadly speaking, the SMF may allow a vendor protection from underestimating conversion rates for future purchases and avoid situations of not being able to ship merchandise whose availability were originally guaranteed. Naturally, the SMF value may be defined by a vendor's need or derived based on historical transaction data. Using an SMF may be useful for modifying the notification quantity without adjusting the base notification quantity assigned to that merchandise type. For example, the SMF may be particularly useful for shopping seasons that may typically have higher conversion rates such as fall and winter.

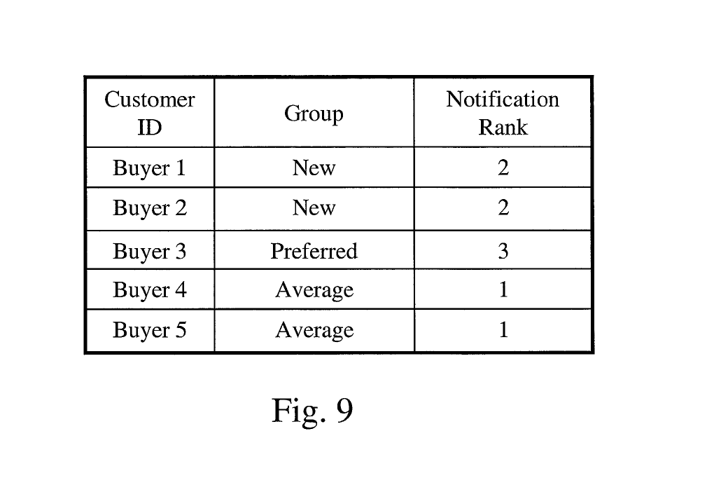

FIG. 9 illustratively shows a portion of another exemplary database table that may be stored in e-commerce database 14. This portion may be stored in notification data 38. Other fields may be populated in e-commerce database 14 and are not shown merely for simplification purposes. The portion may include three data fields, “Customer ID,” “Group,” and “Notification Rank.” Broadly speaking, the “Customer ID” field may be any data that can uniquely identify a buyer toe-commerce server 10. One such example may be a shopper's email address. The field may also be populated by customer identification tags generated by e-commerce server 10 to uniquely identify each shopper. The “Group” field may define communities into which each shopper may be placed in. In this example, this field may include three Group types; New, Preferred, and Average. New may refer to shoppers who have no prior transaction history with the online shopping site or have no customer information stored by e-commerce server 10. Preferred may refer to shoppers who have high conversion rates or shoppers who repeatedly purchase products from the vendor's online shopping site. Average may define the majority of shoppers who visit the shopping site. The “Notification Rank” field may define the hierarchical ranking of the Group types.

The information described in FIG. 9 may be used in the embodiments of the methods described herein. In particular, the methods may be modified to include selectively issuing a notification message to a shopper based on the shopper's group and ranking status. Selectively issuing, or preferably issuing, a notification message may be used to selectively provide different service levels to the different group types. In the example of FIG. 9, the “Preferred” group has a Notification Rank of 3, the “New” group has a rank of 2, and the “Average” group has a rank of 1. Thus, the notification algorithm may be modified to further determine which group and rank shoppers fits into and issue the notification message to lower ranked groups initially before higher ranked groups. Such methods may avoid annoying higher-valued customers, such as the “Preferred” and “New” customers, with notification messages to expedite their purchases. In one example, if an item of merchandise has been determined to exceed the notification quantity level assigned, the method may first notify, using the methods described herein, the “Average” group. If the notification quantity level remains still exceeded, the “New” group may be informed next. Finally, the “Preferred” group may be informed if the situation persists. Other alternative methods may be employed using the notification ranking concepts described herein. Such methods would well be in scope of the invention upon knowledge of the disclosure to one of skill in the art. For example, an alternative method might notify the “Preferred” group initially so that they would have the first opportunity to complete the purchase of high-demand items.

In the methods described herein, execution of the various embodiments may be performed by a server such as e-commerce server 10 that may be a part of a system such as system 5 of FIG. 1. E-commerce sales engine 16 may include program instructions, residing in notification instructions 34 for example, operated to perform the methods discussed above. Alternatively, additional hardware or firmware may be utilized to perform the functions described. The program instructions could also reside in another software module interfacing with e-commerce sales engine 16. The program instructions may be stored on a computer-compatible carrier medium such as the storage medium or transmission medium described herein. Merely as an example, the program instructions may include software code executable to calculate the notification quantity values of the merchandise being offered for sale and to compare the notification quantity values to the aggregate quantity of the merchandise in the unfulfilled shopping carts. Program instructions may further execute the notification algorithms as discussed. Data regarding the quantity of merchandise in unfulfilled shopping carts may be stored in e-commerce database 14 or may be stored upon another storage area not shown. The data may be generated via a cookie present on e-commerce server 10. The cookie is operated to query the entries placed into the shopping carts and store the data onto a storage device such as storage device 15. Other information may also be stored in e-commerce database 14 or another storage area, including the conversion rate values, the safety margin factor values, and the customer grouping and ranking values, for example.

It will be appreciated by those skilled in the art having the benefit of this disclosure that this invention is believed to provide a system and method for managing electronic shopping carts for improved online merchant transactions. Broadly speaking, the invention allows for improving the system and methods of conducting electronic commerce over a network. Furthermore, it is also to be understood that the form of the invention shown and described is to be taken as exemplary, presently preferred embodiments. Various modifications and changes may be made without departing from the spirit and scope of the invention as set forth in the claims. For example, the system and methods described herein may be implemented using many combinations of hardware and/or software, and at one or more of many different levels of hardware and/or software, as is the case with many computer-related applications. It is intended that the following claims be interpreted to embrace all such modifications and changes.

What is claimed is:

1. A method for conducting electronic commerce over a network, comprising:
determining an inventory status of at least one product being considered for purchase by a buyer; and
informing the buyer of a change in the inventory status, wherein said informing precedes any purchase of the product by the buyer.

2. The method of claim 1, wherein the inventory status comprises a level of availability of the product to be shipped to the buyer and the change in inventory status comprises a change in the level of availability of the product to be shipped to the buyer.

3. The method of claim 1, wherein the inventory status comprises a probability of immediate shipment of the product upon purchase by the buyer and the change in the inventory status comprises a change in the probability of immediate shipment of the product upon purchase by the buyer.

4. The method of claim 1, wherein said informing comprises informing the buyer that the product is nearing depletion in the inventory.

5. The method of claim 1, wherein said informing further comprises informing the buyer that the product may not be available for shipment to the buyer unless the product is purchased within a specific timeframe.

6. The method of claim 1, wherein the inventory status comprises a number of other buyers considering the product for purchase and the change in the inventory status comprises a change in the number of other buyers considering the product for purchase.

7. The method of claim 1, wherein said determining comprises examining an entry contained in one or more electronic shopping carts.

8. The method of claim 7, wherein the electronic shopping cart comprises a persistent electronic shopping cart.

9. The method of claim 1, wherein said informing the buyer comprises sending a notification message to the buyer using an electronic mail service.

10. The method of claim 1, wherein said informing the buyer comprises sending a notification message to the buyer using an instant messaging service.

11. The method of claim 1, wherein said informing the buyer comprises displaying a notification message upon a video display screen viewed by the buyer.

12. The method of claim 11, wherein said displaying the notification message comprises using a dynamic content window formed by a Java applet or an ActiveX control script.

13. The method of claim 7, wherein said examining comprises examining the entry stored onto a storage medium of a server.

14. The method of claim 7, wherein said determining comprises comparing an inventory quantity of the product to an aggregate quantity of the product contained in the electronic shopping carts.

15. The method as recited in claim 14, wherein said comparing comprises generating a first notification quantity value by applying a conversion rate factor to the inventory quantity, and said informing occurs if the value of the aggregate quantity is equal to or greater than the value of the first notification quantity value.

16. The method as recited in claim 15, wherein comparing further comprises generating a second notification quantity value by applying a safety margin factor to the first notification quantity value, and said informing occurs if the value of the aggregate quantity is equal to or greater than the value of the second notification quantity value.

17. The method as recited in claim 1, wherein said informing the buyer comprises selectively informing the buyer based on a ranked profile of the buyer.

18. A system for conducting electronic commerce over a network, comprising a server adapted to determine an inventory status of at least one product being considered for purchase by a buyer and further adapted to inform the buyer of a change in the inventory status, wherein said informing the buyer precedes any purchase of the product by the buyer.

19. The system of claim 18, wherein said informing comprises informing the buyer that the product may not be available for shipment to the buyer unless the product is purchased within a specific timeframe.

20. The system of claim 18, wherein the server is further adapted to compare an inventory quantity of the product to an aggregate quantity of the product currently considered for purchase by all buyers.

21. The system of claim 20, wherein the server is further adapted to generate a first notification quantity value by applying a conversion rate factor to the inventory quantity and to generate a second notification quantity value by applying a safety margin factor to the first notification quantity value.

22. The system of claim 21, wherein the server is further adapted to perform said informing the buyer if the value of the aggregate quantity is equal to or greater than either the first or the second notification quantity value.

23. The system of claim 22, wherein the server is further adapted to inform the buyer using a communication means selected from the group comprising an electronic mail service, an instant messaging service, and dynamic content window.

24. The system of claim 23, wherein the e-commerce server is further adapted to selectively inform the buyer based on a ranked profile of the buyer.

25. A system for conducting electronic commerce over a network, said system comprising an electronic commerce server, wherein the electronic commerce server comprises notification instructions stored on one or more storage devices for informing a buyer of a change in inventory status of a product being considered for purchase, wherein said informing precedes any purchase of the product by the buyer.

26. The system of claim 25, wherein the notification instructions further comprises instructions for generating a notification quantity value by applying a conversion rate factor to an inventory quantity of the product and performing said informing if the notification quantity value is equal to or greater than an aggregate quantity of the product currently being considered for purchase by all buyers.

27. The system of claim 26, wherein the electronic commerce server further comprises one or more databases stored on the storage device, wherein the database comprises notification data including the inventory quantity, the aggregate quantity, the conversion rate factor, and the notification quantity value.

28. The system of claim 27, wherein the notification instructions further comprise instructions for selectively informing the buyer based on a ranked profile of the buyer.

29. The system of claim 28, wherein the notification data further comprises data associated with the ranked profile of the buyer.

30. The system of claim 25, further comprising a Web server coupled to the electronic commerce server and adapted to interface with one or more network clients, wherein the network clients provide means for one or more buyers to conduct electronic commerce transactions with the electronic commerce server.

31. A computer-usable carrier medium comprising:
first program instructions executable on a computational device for determining an inventory status of at least one product being considered for purchase by a buyer; and
second program instructions executable on a computational device for informing the buyer of a change in the inventory status, wherein said informing precedes any purchase of the product by the buyer.

32. The carrier medium of claim 31, wherein the first program instructions are further executable for determining an inventory quantity of the product and for determining an aggregate quantity of the product currently being considered for purchase by all buyers.

33. The carrier medium of claim 32, wherein the first program instructions are further executable for generating a first notification quantity value by applying a conversion rate factor to the inventory quantity and generating a second notification value by applying a safety margin factor to the first notification quantity value.

34. The carrier medium of claim 33, wherein the second program instructions are further executable for informing the buyer if either the first or second notification quantity value is equal to or greater than the aggregate quantity.

35. The carrier medium of claim 34, wherein the second program instructions are further executable for selectively informing the buyer based on a ranked profile of the buyer.

36. The carrier medium of claim 35, wherein the second program instructions are further executable for informing the buyer using a communication means selected from the group comprising an electronic mail service, an instant messaging service, and dynamic content window.

37. The carrier medium of claim 35, wherein the second program instructions are further executable for informing the buyer that the product may not be available for shipment if the product is not purchased within a specific timeframe.
